(19) United States
(12) Patent Application Publication
(10) Pub. No.: US 2005/0158632 A1
(43) Pub. Date: Jul. 21, 2005

(54) Alkaline polymer electrolyte membrane and its application

(75) Inventors: Kuei Yung Wang Chen, Taipei (TW); Chun-Chen Yang, Taipei (TW); Sheng-Jen Lin, Taipei (TW)

Correspondence Address: STEVENS DAVIS MILLER & MOSHER, LLP, 1615 L STREET, NW, SUITE 850, WASHINGTON, DC, 20036, US

(73) Assignee: NAN YA PLASTICS CORPORATION, Taipei (TW)

(21) Appl. No.: 11/034,256

(22) Filed: Jan. 13, 2005

(30) Foreign Application Priority Data
Jan. 19, 2004 (TW) 093101333

(51) Int. Cl. H01M 10/26; H01M 2/14; H01M 6/04

(52) U.S. Cl. 429/309; 429/206; 429/303; 429/317; 429/144

(57) ABSTRACT

An alkaline polymer electrolyte membrane formed by mixing hydrophilic PVA, PECH and DMSO organic solvent possessing high mechanical strength and superior electrochemical stability, and with an ionic conductivity higher than 0.01 S/cm under normal temperature which may supersede the traditional PP/PE non-woven fabric separator and KOH electrolyte; in addition, the alkaline polymer electrolyte membrane shall be combined with a base material of glass fiber web, PE/PP porous film and Nylon porous film with thickness of 20 μm˜800 μm to obtain a composite solid-state alkaline polymer electrolyte membrane, which may be used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.

### BACKGROUND OF THE PRESENT INVENTION

1. Field of the Present Invention

The invention relates to an alkaline polymer electrolyte membrane, particularly the alkaline polymer electrolyte membrane formed by mixing hydrophilic polyvinyl alcohol (PVA) with polyepichlorohydrin (PECH) which may be used as a separator membrane on Zinc-air cell.

2. Description of Prior Art

The separator membrane inside cell is the most important part of a cell, this is because the separator in cell is designed for separating anode and cathode to prevent the electron from movement to cause short circuit. In addition, since the separator contains electrolyte which enables the movement of ions between anode and cathode to generate electric potential of cell and electric power.

However, the separator used on conventional cell has the drawback of too big thickness which makes up 40% of the total thickness of the cell.

Therefore, the thickness problem of cell must be solved and overcome in order to achieve the goal of light weight, small thickness, short length and small size of the cell design. Besides the electrolyte contained in the cell separator often suffered from leakage problem that will result in the reduction of the service life of cell.

In order to eliminate the aforesaid drawback of the separator used on conventional cell and improve the performance of the cell, inventions related to the development of cell separator have been disclosed in several patents which proposed different kinds of separator mainly made of polyolefin non-woven fabric such as U.S. Pat. No. 5,585,208 and U.S. Pat. No. 5,830,601, which disclosed a solid-state polymer electrolyte formed by co-polymerization of polyvinyl alcohol (PVA), alkaline metal hydroxide and water. The electrolyte obtained by this way can be used as cell separator to improve cell performance and extend service cell life.

U.S. Pat. No. 6,444,367 disclosed a non-woven fabric with excellent water absorbability capably applied as a separator for a rechargeable alkaline cell.

U.S. Pat. No. 5,401,594 disclosed a hydrophilic non-woven fabric by combination of polyamide and polyolefin fiber to control and adjust the softness and water absorbability of cell separator.

Other known prior arts include to disclose a separator used for a Nickel-hydrogen secondary cell is provided with one side made of hydrophilic polyolefin and another side made of water repellent polyolefin, and an alkaline battery separator is equipped with a hydrophilic polyolefin non-woven mat formed by using heat-fusing and hydrogen-entangling method that enables the cell separator to possess superior breaking strength and electrolyte absorbability.

However, all the existing techniques as mentioned above do not include the polymer electrolyte membrane formed by mixing polyvinyl alcohol (PVA) and polyepichlorohydrin (PECH) with dimethyl sulfoxide (DMSO) as solvent.

### SUMMARY OF THE PRESENT INVENTION

The purpose of the invention is to provide an alkaline polymer electrolyte membrane by admixture of hydrophilic polyvinyl alcohol (PVA) and polyepichlorohydrin (PECH) to possess high mechanical strength and superior electrochemical stability and an ionic conductivity higher than 0.01 S/cm under normal temperature which can supersede traditional PP/PE non-woven fabric separator and KOH electrolyte.

Another purpose of the invention is further to provide a composite solid-state alkaline polymer electrolyte membrane by combining the invented alkaline polymer electrolyte membrane with a base material of glass fiber web, PE/PP porous film and Nylon porous film to increase the mechanical strength, and both the alkaline polymer electrolyte membrane and the composite solid-state alkaline polymer electrolyte membrane shall used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.

### BRIEF DESCRIPTION OF THE DRAWING FIGURES

FIG. 1 is the flow diagram for producing the solid-state alkaline polymer electrolyte membrane made of PVA-PECH admixture of the invention.

FIG. 2 is the Nyquist plot of alternating current impedance of the alkaline electrolyte membrane made of PVA-PECH admixture of the invention.

FIG. 3 is the cyclic voltammetry plot of the alkaline polymer electrolyte membrane made of PVA-PECH admixture of the invention between −1.5˜1.5 volts under electric potential scan speed of 1 mV/s.

FIG. 4A and FIG. 4B are the variation curves of the absorbability and conductivity of the alkaline polymer electrolyte membrane made of PVA-PECH admixture soaked in KOH aqueous solution of 32 wt. % under 25° C., 60RH % for a period of 10˜70 hours.

FIG. 5 are the electric discharge voltage variation curves of a Zinc-air cell installed with the alkaline polymer electrolyte membrane made of PVA/PECH admixture of the invention which is arranged in different composition proportions for the comparison and analysis of the electric characteristics of the cell.

FIG. 6 are the electric discharge voltage variation curves of a zinc-air cell installed with the alkaline polymer electrolyte membrane made of PVA/PECH admixture of the invention under different discharge speed.

### DETAILED DESCRITION OF THE PREFERRED EMBODIMENTS

The alkaline polymer electrolyte membrane disclosed in the invention is made by admixture of PVA (hydrophilic polyvinyl alcohol) and PECH (polyepichlorohydrin) which molecular structure is shown as “—(CH(CH₂Cl)CH₂—O)n-”.

The molecular structure of PVA, shown as “—(CH₂—CH—OH)n-”, shows that it is a semi-crystalline polymer structured by covalent bond and hydrogen bond having the property of resisting the conduction of electron, and is a high-softness polymer.

Since PVA has hydroxyl groups OH it has high hydrophilic property and high affinity with water and KOH which all also have hydroxyl group OH. In addition the movement of ion in the polymer chain of polyvinyl alcohol is achieved by the high coupling interaction between metal ion and polymer backbone to form coordination bond. The electric potential enables ion to move and transmit in the polymer chain of polyvinyl alcohol.

Besides, PECH is a polymer of high solubility with glass transition temperature (Tg) about −40° C., considerable softness under room temperature, and extreme high acid, alkali and weather resistance. The chlorine ion radical (Cl⁻)on the backbone of PECH can carry out anion exchange with the hydroxide ion (OH⁻) in KOH aqueous solution. Since the ion transfer coefficient of hydroxide ion is very high it helps to increase the ion conductivity.

The purpose of the invention is to adopt the advantages of PVA and PECH by mixing them together under specific condition through chemical reaction to obtain alkaline polymer electrolyte.

Since PVA and PECH both are high hydrophilic that results in high hydrogen bonding force, and enables very high mixing effect. And, the polymer electrolyte membrane obtained by this way has not only the high electric conductivity as that of the PVA but also the other advantages same as those of the PVA and PECH such as high ion conductivity, high mechanical strength, high electrochemical stability, high weather, acid and alkali resistance.

Also, since the polymer electrolyte membrane formed by mixing PVA and PECH has very small holes, it has high retardation effect on oxygen that shall prevent the oxygen in air from penetrating the separator membrane to enter into the cathode and react with zinc to generate oxidation effect and can increase the service life of the cell if the membrane is used on zinc-air cell.

In addition, since the polymer electrolyte membrane is soaked with KOH electrolyte, it can be always kept in gel state and will not dry up even installed in the cell for a long time that can extend the storage life of the cell, and can solve the problem of cell alkaline liquid leakage usually caused by the leakage of KOH electrolyte through PP/PE separator membrane.

Especially the alkaline polymer electrolyte membrane disclosed in the invention has the property of ion conductivity higher than 0.01 S/cm under normal temperature and has very high electric conductivity and electrochemical stability even under high temperature, when used on Zinc-air cell, which may enable Zinc-air cell with much better cell performance, electric discharge speed and electric capacity than that of the PP/PE separator used.

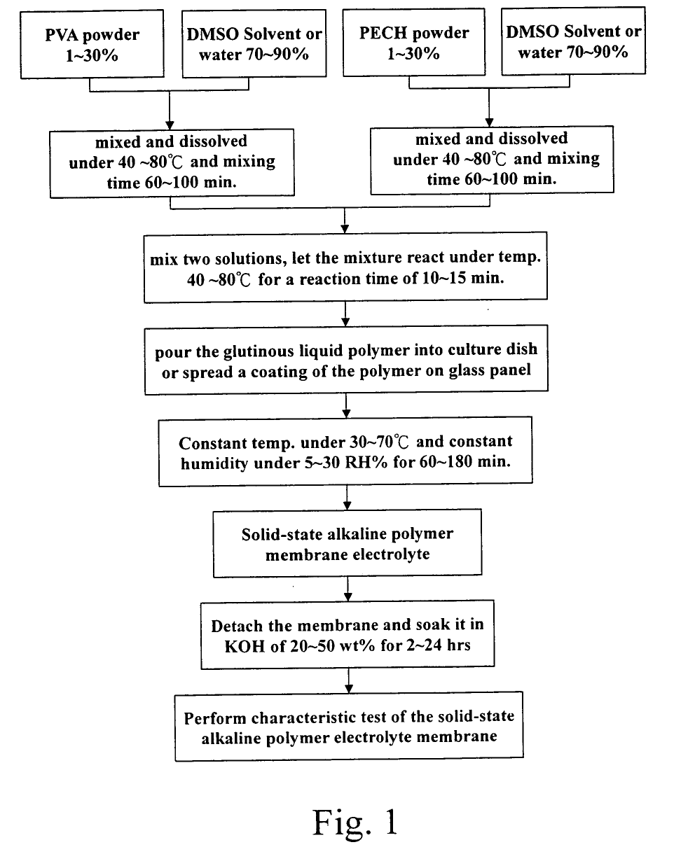

The manufacturing process of the alkaline polymer electrolyte membrane of the invention is shown in FIG. 1 which includes the following steps:
a. choosing PVA granular or powder with average molecular weight between 10,000˜120,000 and purity between 80˜99%, preferably the molecular weight between 20,000˜80,000; and PECH granular or powder with average molecular weight between 50,000˜1,500,000 and purity higher than 50% as raw material, preferably the molecular weight between 100,000˜1,000,000; also choose water or DMSO (Dimethyl sulfoxide) or DMF (dimethyl formamide) with molecular weight of 78 g/mole as organic solvent and the organic solvent employed should be in liquid type;
   then, to dissolve 1˜30% of chosen PVA in 70˜90% DMSO organic solvent or DMF organic solvent or water;
b. having the PVA and PECH perfectly dissolved in DMSO organic solvent under temperature of 40˜80° C., the dissolving time is around 60˜100 minutes; then, mixing the PVA and PECH solution, and stirring the mixture with stirring speed 100˜1500 rpm, under temperature of 40˜80° C. to carry out mixing reaction for a reaction time around 10˜15 minutes to form a mixture of glutinous liquid polymer;
c. spreading a coating of the glutinous liquid polymer obtained from the previous step on glass panel, and controlling thickness of the wet film to a desired thickness, or pouring appropriate amount of the glutinous liquid polymer into a culture dish according to a desired thickness of the membrane to be produced.
d. putting the glass panel or culture dish obtained from the previous step in an environment under temperature of 30˜70° C., relative humidity 5˜30 RH % for a constant temperature and constant humidity drying to let DMSO organic solvent completely evaporated to form dry membrane, wherein the drying time is about 60˜180 minutes;
e. soaking the polymer membrane obtained from the previous step into KOH or alkaline metal hydroxide aqueous solution with 20˜50 wt % and purity higher than 85% for a period about 1˜24 hours to form solid-state alkaline polymer electrolyte membrane. And, the alkaline metal hydroxide aqueous solution may be of sodium hydroxide (NaOH) aqueous solution, lithium hydroxide (LiOH) aqueous solution, mixed type metal hydroxide (such as KOH+LiOH) aqueous solution or organic alkaline compound aqueous solution etc.

Besides in the aforesaid step a the PVA can be added with nanometer grade granules or powder which can be of the metal dioxide materials such as hydrophilic silicon dioxide and titanium dioxide to improve the ion conductivity, electrochemical stability and mechanical strength of the alkaline polymer electrolyte membrane made of the admixture of PVA and PECH.

Moreover, the alkaline polymer electrolyte membrane disclosed in the present invention can be combined with the base material of glass fiber web, PE/PP porous film and Nylon porous film with thickness of 20 μm 800 μm to obtain the composite solid-state alkaline polymer electrolyte membrane to increase the mechanical strength; thermal stability and electrochemical stability of the alkaline electrolyte membrane. However, the fiberglass web must be heated in methyl alcohol (CH₃OH) or ethyl alcohol (C₂H₅OH) to boiling point for a period of time for hydrophilic treatment before it is used for making alkaline electrolyte membrane.

### EXAMPLE 1

Respectively based on the formula of specific proportions of PVA:PECH=1:1.0; PVA:PECH=1:1.5; or PVA:PECH=1:2.0, to precisely measure 5.0 g PVA and put it in a reactor containing 30 ml DMSO, and hold it in reaction for a period of 1 hour under a temperature of 60° C. until it is completely dissolved. Then put 5˜10 g PECH in another reactor containing 30 ml DMSO, and hold it in reaction for 1 hour under a temperature of 60° C. until it is completely dissolved, than pour the PECH solution into the reactor containing PVA solution.

Raise the reactor temperature to 50˜70° C., and hold the reaction continued for a time of 30 minutes. After finishing the reaction pour the glutinous liquid polymer into a culture dish with diameter of 10 cm, and control the weight of the polymer admixture poured into the dish about 5˜10 g, then put the dish in a thermostatic chamber with constant humidity of 5 RH % and temperature of 80° C. for a period about 12 hours.

Then take the culture dish out from the chamber and put it in atmosphere for 1 hour. Detach the polymer membrane from the dish and measure the weight, than soak it into 32 wt % potassium hydroxide aqueous solution for 12˜24 hours and then absorb the remaining liquid on the surface of the membrane by dust-free paper. By measure weight of the membrane goes to calculate the percentage (%) absorption of solution, i.e. the absorptivity. A thickness of 0.02 cm of the membrane is measured by digital thickness meter.

Test of Conductivity

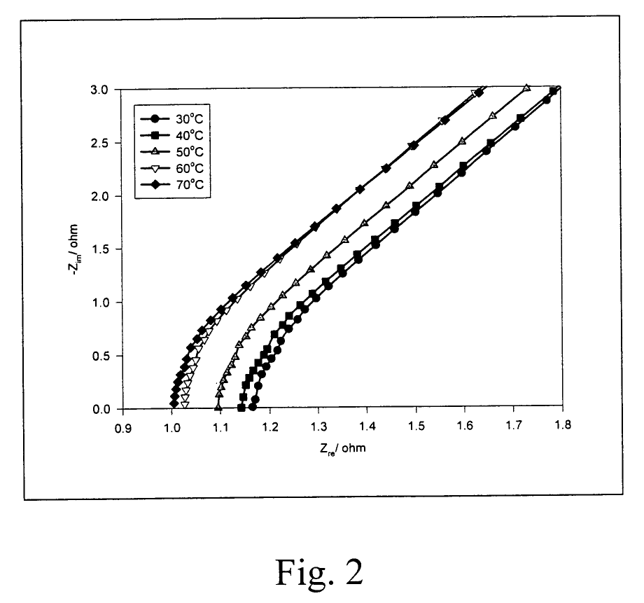

The ionic conductivity of the solid-state alkaline polymer electrolyte membrane made of the admixture of PVA and PECH of different composition proportion is measure by Electrochemical Impedance Analyzer manufactured by Autolab Fra which specification has two-pole stainless steel electrodes, range of frequency scanned under 0.1 Hz˜100 KHz, and the amplitude of 10 mV. The measuring result of alternative current impedance is shown in FIG. 2.

From FIG. 2, it shows that the solid-state alkaline polymer electrolyte membrane made of the admixture of PVA and PECH has a resistance (Rb) 1.18 ohm under normal temperature of 30° C., and has a resistance (Rb) of 1.15 Ohm, 1.08 Ohm, 1.03 ohm and 1.01 ohm under temperature of 40° C., 50° C., 60° C. and 70° C. respectively.

The measured area of the membrane is 0.785 cm². The ionic conductivity (σ) of the membrane is calculated by formula of σ=T/(R×A),
where
   σ: conductivity (1/ohm-cm, S/cm)
   T: membrane thickness (cm)
   R: resistance (ohm)
   A: measured area (cm²)

and the variation of the ionic conductivity under different temperature of 30° C., 40° C., 50° C., 60° C. and 70° C. respectively is shown in Table 1, wherein the solid-state polymer electrolyte membrane made of the admixture of PVA and PECH with a mixing ratio of 1:1 has an ionic conductivity about 0.02 S/cm under normal temperature of 30° C.

TABLE 1

Composition Ratio

| | PVA:PECH = 1:1 | PVA:PECH = 1:1.5 |
|---|---|---|
| Temp. (° C.) | Conductivity (S/cm) | |
| 30 | 0.0219 | 0.00459 |
| 40 | 0.0233 | 0.00462 |
| 50 | 0.0238 | 0.00469 |
| 60 | 0.0248 | 0.00480 |
| 70 | 0.0254 | 0.00497 |

Electrochemical Stability Test:

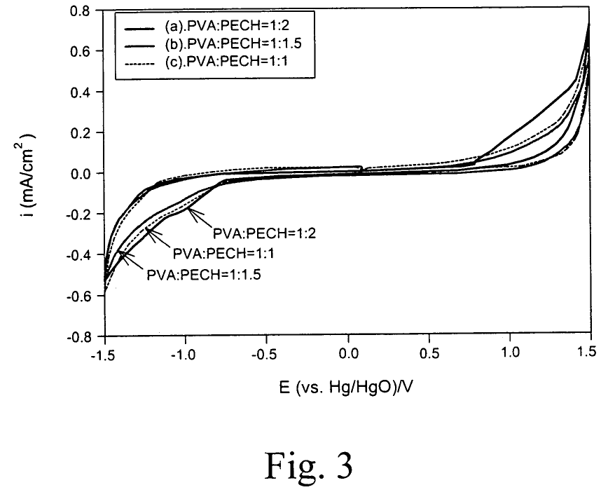

To make scan by Autolab GPES goes to test the cyclic Voltammetry t-Ampere characteristics of the polymer electrolyte of different chemical composition of PVA/PECH, the test result is shown in FIG. 3, and the Autolab GPES has a Two-pole type measuring method which has range of electric potential under −1.5˜1.5V, scan rate of 1 mV/S, and working electrode made of stainless steel of SS316.

From FIG. 3, it shows that the alkaline polymer electrolyte membrane of the invention made of PVA and PECH admixture has no any oxidation and reduction reaction under normal temperature of 30° C. and working voltage under −1.0˜1.0V, i.e. generates no any Faradic current flow, these represent that the polymer electrolyte membrane has very good electrochemical stability within this field of application.

Test of Mechanical Strength:

The mechanical strength is tested by Universal Testing Machine. The tensile speed is 200 m/min. The tensile strength of the solid-state alkaline polymer electrolyte under temperature of 25° C. and humidity of 60 RH % is shown in Table 2

TABLE 2

| | Test item | | | | |
|---|---|---|---|---|---|
| Composition | Thickness | Width | Strength | Stress | Elongation |
| Proportion | (mm) | (mm) | (kg) | (kg/cm²) | (%) |
| PVA:PECH = 1:0 | 0.16 | 10 | 0.6 | 37.5 | 457 |
| PVA:PECH = 1:1 | 0.09 | 10 | 5.3 | 589 | 303 |
| PVA:PECH = | 0.13 | 10 | 3.4 | 262 | 106 |
| 1:1.5 | | | | | |

### EXAMPLE 2

Choose one of the solid-state alkaline polymer electrolyte membrane made of the admixture of PVA and PECH of example 1 as test sample. Cut the membrane into size of 5 cm×5 cm, and soak the membrane in KOH aqueous solution of 32 wt %.

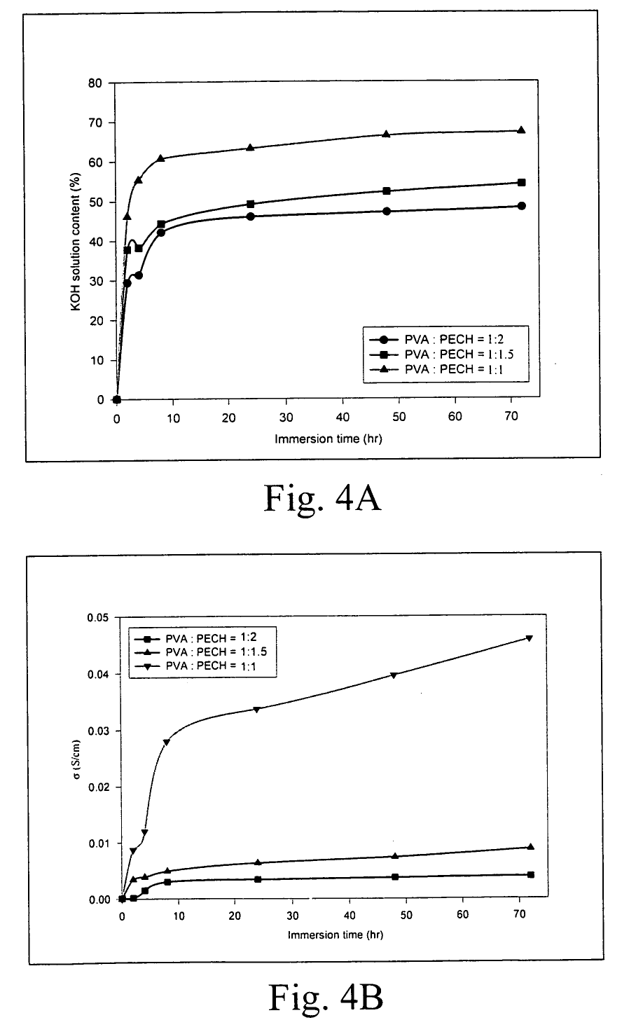

The variation of soaking time versus the amount of KOH aqueous solution contained in the polymer electrolyte membrane is shown in FIG. 4A. The effect of soaking time on the ionic conductivity of the polymer electrolyte membrane is shown in FIG. 4B.

From FIG. 4A, it shows that the solid-state alkaline electrolyte membrane with a PVA/PECH mixing ratio of 1:1 has the highest absorbability of KOH aqueous solution which can reach a rate of adsorption higher than 60% after 10 hours soaking, and the membrane with PAV/PECH mixing ration of 1:1.5 or 1:2 presents an adsorption around 40˜60 wt %.

From FIG. 4B, it also shows that when the solid-state alkaline electrolyte membrane made of admixture of PVA and PECH is soaked in KOH aqueous solution, the increase of adsorption time always accompanied by an increase of ionic conductivity, and the membrane having PVA/PECH mixing ratio of 1:1 has the highest conductivity which can reach a value of 0.03 S/cm after 10 hours soaking.

### EXAMPLE 3

Measure 3 g zinc gel containing 60% zinc powder as the cathode, and use an air-electrode made of carbon powder as anode to construct a zinc-air cell, and choose one of the solid-state alkaline polymer membrane made of PVA/PECH admixture of example 1 as separator electrolyte, and installed the membrane between the zinc electrode and air electrode.

The whole assembly was installed in an acrylic case with size of 3 cm length by 2 cm width and area of 6 cm² to form a zinc-air cell, and the electric discharge test were performed under different electric discharge speed, i.e. under different current of C/5, C/10 and C/20. The test results are shown in Table 3 and Table 4.

TABLE 3
Electric discharge characteristics of zinc-air cell
installed with alkaline polymer electrolyte membrane
made of the admixture of PVA and PECH of different
composition proportions under electric discharge speed of C/10.

| | Electrolyte of Composition Proportion | |
|---|---|---|
| Test item | PVA:PECH = 1:1 | PVA:PECH = 1:1.5 |
| Theoretical electric capacity | 1,476 | 1,476 |
| (mAh) | | |
| Discharge current (mA) | 150 | 150 |
| Discharge time (hr) | 8.60 | 7.73 |
| Actual electric Capacity (mAh) | 1290 | 1160 |
| Usability (%) | 86.1 | 77.0 |

TABLE 4
Comparison of electric discharge usability of Zinc-air cell
installed with the solid-state polymer electrolyte membrane
made of the admixture of PVA and PECH with mixing ratio of
PVA:PECH = 1:1, under different electric discharge speed.

| | Separator of Composition Proportion | | |
|---|---|---|---|
| Test item | C/5 | C/10 | C/20 |
| Theoretical electric capacity (mAh) | 1,476 | 1,476 | 1,476 |
| Discharge current (mA) | 300 | 150 | 75 |
| Discharge time (hr) | 3.69 | 8.59 | 17.28 |
| Actual electric Capacity (mAh) | 1107 | 1289 | 1296 |
| Usability (%) | 73.8 | 85.9 | 86.4 |

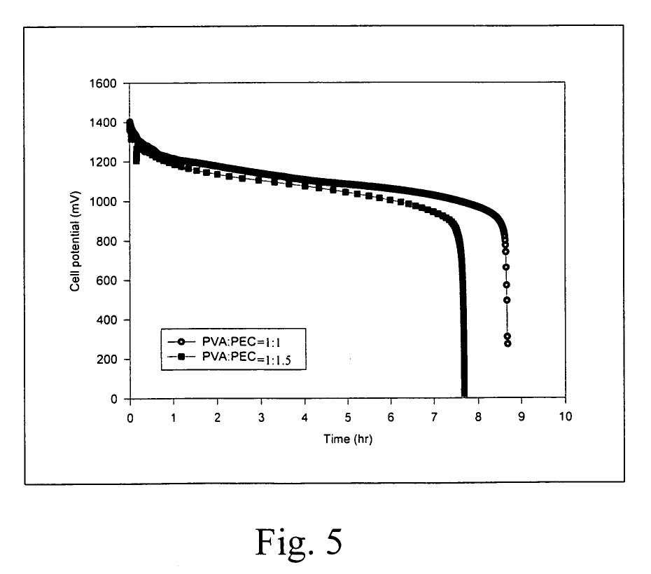

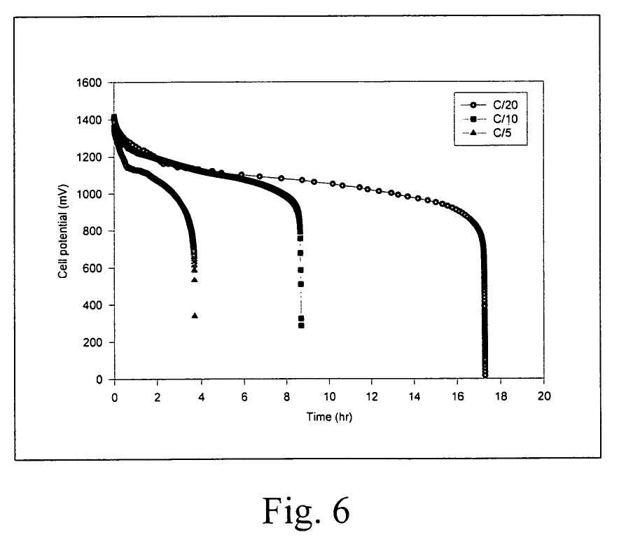

Based on the theoretical electric capacity of 1470 mAh, carry out constant current discharge under temp of 25° C., discharge rate C/10, the variation of cell potential versus time is shown in FIG. 5. And, FIG. 6 shows the variation curve of cell potential versus time of a zinc-air cell under different discharge speed of C/20, C/10, and C/5.

1. An alkaline polymer electrolyte membrane made by admixture of hydrophilic PVA, PECH and DMSO organic solvent through the manufacturing process comprising the following steps:
a. dissolve PECH of 1˜30 wt % in DMSO organic solvent of 70˜90 wt % under temperature of 40˜80° C., and wait for a period around 60˜100 minutes until it is completely dissolved;
b. dissolve PVA of 1˜30 wt % in DMSO organic solvent of 70˜90 wt % under temperature of 40˜80° C., and wait for a period around 60˜100 minutes until it is completely dissolved;
c. mix the dissolved glutinous liquid polymer obtained from step a and atep b to carry out polymer mixing reaction under temperature of 40˜80° C., and the mixture is stirred with stirring speed of 100˜1500 rpm for a period around 10˜15 minutes, then stop the reaction;
d. spread a coating of the glutinous liquid polymer on glass panel, and control the thickness of the polymer on glass panel, or pour the polymer into culture dish, and control the amount of polymer poured into the dish according to the desired membrane thickness;
e. put the glass panel or culture dish from step d in an environment under temperature of 30˜70° C. and humidity of 5˜30 RH % for constant temperature and constant humidity drying to completely evaporate the DMSO organic solvent through an evaporation time about 60˜180 minutes; and
f. finally detach the solid polymer from the glass panel or culture dish, and soak it in KOH or alkaline metal hydroxide aqueous solution for a period of 2˜24 hours to obtain finished solid-state alkaline polymer electrolyte membrane.

2. The alkaline polymer electrolyte membrane as described in claim 1, wherein the DMSO organic solvent used in step a and step b is replaced with water.

3. The alkaline polymer electrolyte membrane as described in claim 1, wherein the DMSO organic solvent used in step a and step b is replaced with DMF.

4. The alkaline polymer electrolyte membrane as described in claim 1, wherein the reactant of PVA used in the production steps has a molecular weight averagely between 20,000˜80,000 and a weight percentage between 1˜50 wt %.

5. The alkaline polymer electrolyte membrane as described in claim 4, wherein the purity of PVA is higher than 80%.

6. The alkaline polymer electrolyte membrane as described in claim 1, wherein the reactant of PECH used in the production steps has a molecular weight averagely between 100,000˜1,000,000 and a weight percentage between 1˜50 wt. %.

7. The alkaline polymer electrolyte membrane as described in claim 1, wherein the alkaline metal hydroxide aqueous solution used in step f shall be of NaOH, LiOH or mixing type alkaline metal hydroxide aqueous solution such as aqueous solution of KOH+LiOH or organic alkaline compound.

8. The alkaline polymer electrolyte membrane as described in claim 1, wherein the nanometer grade granulate or powder added into the PVA used in the production steps shall be of the metal hydroxide material of hydrophilic silicon dioxide or titanium dioxide.

9. The alkaline polymer electrolyte membrane as described in claim 1, wherein the membrane may further be formed into a composite solid-state alkaline polymer electrolyte membrane by combining a base material of fiber glass web, porous PE/PP film or porous nylon film having thickness between 20 μm ˜800 μm with the alkaline polymer electrolyte membrane.

10. The alkaline polymer electrolyte membrane as described in claim 1, which is used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.

11. The alkaline polymer electrolyte membrane as described in claim 2, which is used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.

12. The alkaline polymer electrolyte membrane as described in claim 3, which is used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.

13. The composite solid-state alkaline polymer electrolyte membrane as described in claim 9, which is used as a separator membrane applicably inside a Zinc-air cell, a Nickel-hydrogen cell, a nickel-cadmium cell, a nickel-zinc cell, a fuel cell, a metal-air cell, a primary and secondary alkaline (Zn—MnO₂) cells, and an alkaline capacitors.
